(19) United States
(12) Patent Application Publication
(10) Pub. No.: US 2026/0138605 A1
(43) Pub. Date: May 21, 2026

(54) CONTROL DEVICE AND METHOD FOR CONTROLLING VEHICLE SPEED

(71) Applicant: Scania CV AB, Södertälje (SE)

(72) Inventors: Mikael ALENIUS, Segeltorp (SE); Frank MOHR, Värmdö (SE); Oliver SOMOS, Hägersten (SE); Oscar FLÄRDH, Älvsjö (SE); Henrik SANDSTEDT, Hägersten (SE)

(73) Assignee: Scania CV AB, Södertälje (SE)

(21) Appl. No.: 19/114,647

(22) PCT Filed: Oct. 4, 2023
(86) PCT No.: PCT/SE2023/050987

§ 371 Date: Mar. 24, 2025

(30) Foreign Application Priority Data
Oct. 14, 2022 (SE) 2251205-7

(51) Int. Cl. B60W 30/14; B60W 30/18

(52) U.S. Cl. CPC B60W 30/143; B60W 30/18072; B60W 30/18109; B60W 2552/20; B60W 2720/103

(57) ABSTRACT

A control device and a method for controlling vehicle speed are provided. The method comprises determining a maximum allowable vehicle speed profile for an upcoming road section comprising an event expected to require a reduction of vehicle speed. The method further comprises determining a desired vehicle speed profile to reach a minimum point of the determined maximum allowable speed profile while avoiding vehicle speeds above the determined maximum allowable vehicle speed profile. The method further comprises simulating a vehicle speed profile for a first brake mode, and when the simulated vehicle speed profile for the first brake mode fulfils at least a first predefined criterion, braking the vehicle in accordance with the first brake mode.

### TECHNICAL FIELD

The present disclosure relates in general to a method for controlling vehicle speed of a vehicle. The present disclosure further relates in general to a control device configured to control vehicle speed of a vehicle. Moreover, the present disclosure relates in general to a computer program as well as a computer-readable medium. Furthermore, the present disclosure relates in general to a cruise control system configured to control vehicle speed of a vehicle. The present disclosure also relates in general to a vehicle.

### BACKGROUND

Heavy vehicles, such as busses and trucks, are today often equipped with various control systems configured to control the operation of the vehicle for various purposes, such as to improve safety, reduce energy consumption of the vehicle, and/or improve driver comfort. Some of these control systems are configured to predict a future behavior of the vehicle, taking into account for example data regarding characteristics of upcoming road sections, if the vehicle is controlled according to different control strategies. These predictions, which may be determined through simulations, are thereafter used for the purpose of determining the most appropriate strategy for controlling the vehicle for the upcoming road section.

Some control systems configured to control the operation of the vehicle may be activated and deactivated by e.g. a driver of the vehicle. In certain situations, such control systems may cause the vehicle to behave differently from what may be expected by the driver and/or in a way that causes irritation to the driver. This may in turn lead to the driver deactivating the control system and thereby not taking advantage of the benefits achievable by the control system. It is therefore important to develop control systems that cause the vehicle to behave as expected by the driver and which do not risk causing annoyance to the driver.

One specific example of a control system that may be activated/deactivated by a driver of the vehicle and thereby is dependent of the driver's willingness to utilize the control system is a cruise control system. When activated, a cruise control system for example avoids the need of a driver to operate an accelerator pedal in order to maintain the vehicle speed and thereby improves driver comfort. There are various types of cruise controls. These are configured to operate according to different control functions and therefore may result in different effects on for example the operation of the vehicle.

For example, a constant speed cruise control aims at maintaining a substantially constant vehicle speed, such as a set speed selected by a driver of the vehicle, and is therefore typically configured to maintain the vehicle speed within a relative narrow allowable speed range about the set speed. A constant speed cruise control thus controls the vehicle with the aim to maintain the set speed regardless of whether the vehicle is travelling uphill, downhill or on a horizontal running surface. This means that the vehicle may be accelerated over the crest of a hill, only to be immediately braked on a subsequent downgrade to avoid exceeding the set speed. Although such a cruise control will cause the vehicle to behave as expected by the driver, this is an uneconomic way of running the vehicle, particularly in the case of heavy vehicles, since it may often unduly increase the energy consumption of the vehicle and hence the operating costs (such as fuel costs).

Another type of cruise control is a look-ahead cruise control (sometimes also referred to as a predictive cruise control). A look-ahead cruise control is a cruise control which uses information regarding an upcoming road section, i.e. a road section ahead of the vehicle, and that may plan a vehicle speed profile for the upcoming road section based on said information. Said information regarding the upcoming road section may typically be derived from map data in combination with information regarding geographical positioning of the vehicle, but may in some situations also be derived from sensors arranged in or on the vehicle and/or supplemented with for example historical data relating to the upcoming road section. The look-ahead cruise control may thereafter control the vehicle speed in accordance with the planned vehicle speed profile as the vehicle travels the road section in question. Look-ahead cruise controllers have the advantage of being able to save substantial amounts of energy (such as fuel) compared to conventional constant speed cruise controllers. For example, in case the upcoming road section comprises an uphill followed by a downhill, the vehicle may be accelerated so as to, at the crest of the hill, having a speed which is lower than the set speed if the vehicle speed will increase during the downhill so as to reach the set speed. In order to take advantage of the positive effect obtainable by a look-ahead cruise control, the allowable speed range of the vehicle for such a cruise control is typically considerably broader than the allowable speed range of a constant speed cruise control. However, the variations in vehicle speed when using a look-ahead cruise control may sometimes be seen as disturbing by drivers, who may in such cases choose to deactivate the look-ahead cruise control. This may in turn lead to an increased energy consumption of the vehicle and thus increased operating costs.

Yet another example of a cruise control is an adaptive cruise control, which is configured to automatically adjust the vehicle speed in order to maintain a safe distance to one or more vehicles ahead of the vehicle comprising the adaptive cruise control. An adaptive cruise control typically uses information from sensors arranged in or on the vehicle, such as radar, laser or cameras, for the purpose of obtaining information regarding the surroundings of the vehicle. It should here be noted that both a constant speed cruise control and a look-ahead cruise control may be supplemented with an adaptive cruise control function, if desired.

Cruise control systems are in general developed primarily for highway driving. It would however be desirable to be able to utilize the advantages of for example a look-ahead cruise control also when driving on country roads. Such roads may however comprise various additional situations that need to be taken into account compared to highways. For example, country roads may comprise sharper curves, junctions, roundabouts, stop signs etc., which may require a considerable adjustment of vehicle speed.

### SUMMARY

The object of the present invention is to enable an improved method for reduction of vehicle speed which allows the vehicle to maintain a safe vehicle speed for passing a road event that is expected to require a reduction of vehicle speed, and which does not rely on actions taken by a possible driver of the vehicle.

The object is achieved by the subject-matter of the appended independent claim(s).

The present disclosure provides a method, performed by a control device, for controlling vehicle speed of a vehicle. The method comprises a step of determining a maximum allowable vehicle speed profile for an upcoming road section comprising an event expected to require a reduction of vehicle speed. The method further comprises a step of, based on the determined maximum allowable vehicle speed profile, determining a desired vehicle speed profile to reach a minimum point of the determined maximum allowable speed profile while avoiding vehicle speeds above the determined maximum allowable vehicle speed profile. Said desired vehicle speed profile is designed to achieve a desired characteristic. The method further comprises a step of simulating vehicle speed for at least an initial portion of the upcoming road section in case the vehicle would be braked according to a first brake mode, thereby obtaining a simulated vehicle speed profile for the first brake mode. The method further comprises a step of, when the obtained simulated vehicle speed profile for the first brake mode fulfils at least a first predefined criterion, which is dependent of the determined desired vehicle speed profile, braking the vehicle in accordance with the first brake mode.

The herein described method enables a controlled reduction of vehicle speed when the vehicle travels along a road section which comprises an event requiring a reduction of vehicle speed compared to for example a current vehicle speed or a currently targeted vehicle speed without compromising safety in the operation of the vehicle or a desired characteristic in the operation of the vehicle, while at the same time avoiding an unduly low average travelling speed for the road section. This in turn has the advantage of the vehicle behaving as may be expected by for example a driver of the vehicle or by other traffic.

The method may further comprise a step of simulating vehicle speed for at least said initial portion of the upcoming road section in case the vehicle would be braked according to a second brake mode, thereby obtaining a simulated vehicle speed profile for the second brake mode. Said step may be followed by a step of, when the obtained simulated vehicle speed profile for the first brake mode does not fulfil said first predefined criterion and the obtained simulated vehicle speed profile for the second brake mode fulfils at least the first predefined criterion, braking the vehicle in accordance with the second brake mode. Thereby, a suitable braking mode may be identified and utilized even if the simulated vehicle speed profile for the first brake mode does not fulfil the first predefined criterion.

The first predefined criterion may suitably be that a difference between the integral of the desired vehicle speed profile and an integral of the simulated vehicle speed profile, for a defined distance interval, is less than a predefined threshold value, optionally in combination with said difference being equal to or above zero. Said distance interval is defined by a distance point corresponding to an initial vehicle position for which the simulated vehicle speed profile has been made and a distance point at which the simulated vehicle speed profile coincides with the desired vehicle speed profile. By means of such a first predefined criterion, the loss of distance of the vehicle while traveling along the road section is reduced.

The method may further comprise a step of, based on the obtained simulated vehicle speed profile for the first brake mode, determining a duration of braking until the simulated vehicle speed profile coincides with the desired vehicle speed profile. If so, the step of braking the vehicle in accordance with the first brake mode may be performed when the determined duration is equal to or above a predefined minimum acceptable duration for the first brake mode. Thereby, it may be avoided that the braking mode used for braking the vehicle needs to be altered shortly after having been activated, which could for example increase the wear of constituent components of the vehicle. This is particularly the case when an alteration of brake mode may involve connecting/disconnecting a clutch and/or performing a gear change, or even mechanically connecting/disconnecting a brake system.

The method may further comprise a step of, while the vehicle is braked in accordance with the first brake mode and before the vehicle reaches the minimum point of the determined maximum allowable speed profile, simulating vehicle speed for at least an adjacent portion of the upcoming road section in case the vehicle would be braked according to a third brake mode. Thereby, a simulated vehicle speed profile for the third brake mode is obtained. The method may then comprise, when the obtained simulated vehicle speed profile for the third brake mode fulfils at least the first predefined criterion, braking the vehicle in accordance with the third brake mode. Thereby, braking of the vehicle may be altered to a more suitable brake mode for a portion of the (initially upcoming) road section and at appropriate distance prior to the vehicle reaching the minimum point of the determined maximum allowable speed profile.

The method according to the present disclosure may optionally further comprise a step of, when the vehicle (i) reaches a distance point which is equal to or less than a predetermined distance from the minimum point of the determined maximum allowable speed profile, (ii) is estimated to reach a distance point corresponding to the minimum point of the determined maximum allowable speed profile within a predefined duration, and/or (iii) reaches a vehicle speed within a predetermined acceptable speed range of the minimum point of the determined maximum allowable speed profile, determining whether the vehicle may reach a vehicle speed equal to or lower than a vehicle speed of the minimum point of the determined maximum allowable speed profile at said minimum point of the determined maximum allowable speed through braking of the vehicle by coasting. In case it is determined that the vehicle may reach a vehicle speed equal to or lower than the vehicle speed of the minimum point of the determined maximum allowable speed profile at the minimum point of the determined maximum allowable speed profile through braking the vehicle by coasting, the method may comprise initiating braking of the vehicle by coasting. Thereby, a safe and an energy efficient reduction of vehicle speed to the minimum point of the determined maximum allowable speed profile may be achieved.

The method as described herein may suitably be incorporated in a cruise control of the vehicle. Thereby, the herein described method may for example be configured to temporarily override a control function configured to essentially maintain a set speed selected by a driver or another control system of the vehicle in case of the upcoming road section comprising an event expected to require a reduction of vehicle speed. Thereby, the cruise control may be used over a larger range of driving situations, such as also when driving on country roads comprising more events that may require alteration of vehicle speed compared to highway driving. Furthermore, when a cruise control comprises the herein described method, the vehicle may be safely and efficiently operated without compromising driver comfort or behaving in a manner which is unexpected by e.g. a driver of the vehicle or surrounding traffic.

The above mentioned event expected to require a reduction of vehicle speed may for example comprise, or consist of, a curve of the road, a junction, a roundabout and/or a speed sign.

The method may further comprise a step of determining that an upcoming road section for the vehicle comprises an event expected to require a reduction of vehicle speed based on data selected from the group comprising data relating to the vehicle's geographical position in combination with map data or historical data, data obtained from another vehicle and/or from infrastructure, and/or data obtained from one or more sensors onboard the vehicle.

The present disclosure also provides a computer program comprising instructions which, when executed by a control device, cause the control device to carry out the method as described above.

The present disclosure also provides a computer-readable medium comprising instructions which, when executed by a control device, cause the control device to carry out the method as described above.

Furthermore, the present disclosure provides a control device configured to control vehicle speed of a vehicle. The control device is configured to determine a maximum allowable vehicle speed profile for an upcoming road section comprising an event expected to require a reduction of vehicle speed. The control device is further configured to, based on the determined maximum allowable vehicle speed profile, determine a desired vehicle speed profile to reach a minimum point of the determined maximum allowable speed profile while avoiding vehicle speeds above the maximum allowable vehicle speed profile, said desired vehicle speed profile being designed to achieve a desired characteristic. The control device is further configured to simulate vehicle speed for at least an initial portion of the upcoming road section in case the vehicle would be braked according to a first brake mode, thereby obtaining a simulated vehicle speed profile for the first brake mode. Moreover, the control device is configured to, when the obtained simulated vehicle speed profile for the first brake mode fulfils at least a first predefined criterion, which is dependent of the determined desired vehicle speed profile, braking the vehicle in accordance with the first brake mode.

The control device provides the same advantages as described above with regard to the corresponding method for controlling vehicle speed of a vehicle.

The present disclosure further provides a cruise control system configured to control the vehicle speed of a vehicle. The cruise control system comprises the control device configured to control vehicle speed of a vehicle as described above.

The present disclosure also provides a vehicle comprising the control device configured to control vehicle speed of a vehicle as described above. The vehicle may be a heavy vehicle, such as a bus or a truck, but is not limited thereto. Furthermore, the vehicle may be a vehicle partly or fully operated by a driver or be a fully autonomous vehicle. Moreover, the vehicle may be driven by a combustion engine, be a hybrid vehicle, or be a fully electric vehicle.

### BRIEF DESCRIPTION OF DRAWINGS

FIG. 1 schematically illustrates a side view of an example of a vehicle,

FIG. 2 schematically illustrates an exemplifying situation where a vehicle travels on a road and where an upcoming road section comprises an event that may require a reduction of vehicle speed,

FIG. 3 represents a flowchart schematically illustrating one exemplifying embodiment of the herein described method for controlling vehicle speed of a vehicle,

FIG. 4 represents a graph of vehicle speed versus distance for an example of an upcoming road section comprising an event requiring a reduction of vehicle speed,

FIG. 5 schematically illustrates an exemplifying embodiment of a device that may comprise, consist of, or be comprised in the herein described control device configured control vehicle speed of a vehicle.

### DETAILED DESCRIPTION

The invention will be described in more detail below with reference to exemplifying embodiments and the accompanying drawings. The invention is however not limited to the exemplifying embodiments discussed and/or shown in the drawings, but may be varied within the scope of the appended claims. Furthermore, the drawings shall not be considered drawn to scale as some features may be exaggerated in order to more clearly illustrate the invention or features thereof.

The herein described method for controlling vehicle speed has primarily been developed with the purpose of increasing a driver's willingness to utilize control functions available in a vehicle and thus taking advantage of the intended purposes of such control functions, such as reduced energy consumption of the vehicle, improved safety and/or increased comfort. It should however be noted that the herein described method may also advantageously be used in vehicles not operated by a driver, i.e. autonomous vehicles.

The term “driver” is in the present disclosure considered to encompass a person available onboard the vehicle and driving the vehicle as well as a person controlling the vehicle from a location remote from the vehicle (such as at a remote control center), unless explicitly disclosed otherwise.

The term “brake mode” is in the present disclosure intended to mean a control mode through which a reduction of vehicle speed may be achieved. A brake mode may be achieved by usage of one or more brake systems of the vehicle. Where a brake mode comprises usage of more than one brake system of the vehicle, these brake systems are simultaneously operated to provide a braking force (for example in the form of a braking torque). Examples of brake systems of a vehicle include various auxiliary brake systems, including various engine brake systems (such as an exhaust brake system, a compression release braking system or a variable vane braking system), a regenerative brake system, and a retarder, but is not limited thereto. Another example of a brake system of a vehicle is the service brakes. It is commonly known that, for some auxiliary brake systems, the deliverable braking torque is dependent of the speed of the vehicle's propulsion unit. In such cases, a brake mode may be associated with a current gear ratio of a gearbox of the vehicle. A brake mode made may alternatively comprise freewheeling or coasting the vehicle. Alternatively, a brake mode may be achieved by a controlled reduction of the propulsion force provided by a propulsion unit of the vehicle for the purpose of reducing the vehicle speed (without usage of a brake system of the vehicle or putting the gearbox in neutral).

Freewheeling is in the present disclosure considered to mean, in case the vehicle comprises a combustion engine as a propulsion unit, disconnecting the combustion engine from the gearbox, typically by opening a clutch, or putting the gearbox in neutral. Depending on the circumstances, the combustion engine may sometimes be turned off during freewheeling for the purpose of reducing energy consumption (i.e. fuel consumption), but typically the combustion engine is kept idling. Freewheeling with combustion engine off is sometimes also referred to as “gliding”. For an electric vehicle, freewheeling is in the present disclosure considered to mean that the gearbox is put in neutral and the electrical machine, constituting a propulsion unit of the vehicle, is shut down. In some cases, the inverter controlling the electrical machine may also be turned off for the purpose of further reducing energy consumption during freewheeling.

Coasting is in the present disclosure considered to mean, in case the vehicle comprises a combustion engine as a propulsion unit, turning off the combustion engine while keeping the combustion engine connected to the gearbox. A gear is engaged during coasting (i.e. the gearbox is not in neutral). During coasting, the kinetic energy of the vehicle is used for dragging the combustion engine, which in turn provides a braking force to the vehicle. Coasting may also be achieved when the vehicle comprises a propulsion unit in the form of an electrical machine. Also in this case, the kinetic energy of the vehicle is used for dragging the electrical machine, which provides a braking force to the vehicle.

Furthermore, in the present disclosure the term “distance point” is used to describe a geographical position located somewhere along the upcoming road section.

In the present disclosure, the term “vehicle speed” is used for describing a traveling speed of a vehicle. However, a distinction is made between an actual or current vehicle speed and a predicted or simulated vehicle speed. A predicted or simulated vehicle speed is not an actual current vehicle speed, but a calculated or estimated future vehicle speed.

In accordance with the present disclosure, a method for controlling vehicle speed is provided. The method is performed by a control device configured therefore. The herein described method comprises a step of determining a maximum allowable vehicle speed profile for an upcoming road section comprising an event expected to require a reduction of vehicle speed. An upcoming road section is herein used to describe a section of the road in front of the vehicle, and which the vehicle is about to travel on. The upcoming road section may according to one alternative be immediately in front of the vehicle. In other words, the upcoming road section may start from a current position of the vehicle. Alternatively, the upcoming road section, for which the maximum allowable vehicle speed profile is determined, may be in front of a current vehicle position by a preselected distance, for example starting 10 meters, 50 meters or 100 meters in front of the vehicle. Examples of an event expected to require a reduction of vehicle speed may include one or more curves of the road, a junction, a roundabout, and/or a speed sign, but is not limited thereto. An event expected to require a reduction of vehicle speed need not necessarily be something that is permanent, but could also be a temporary event, such as road work, a queue, or a traffic accident.

The presence of an event expected to require a reduction of vehicle speed, and the characteristics thereof, may be determined based on geographical positioning data of the vehicle in combination with map data, based on information from sensors onboard the vehicle, based on stored historical data relating to the upcoming road section in combination with geographical positioning data of the vehicle, and/or based on information received from other vehicles and/or infrastructure (for example received via a conventional V2X communication system). The presence and the characteristics of the event expected to require a reduction of vehicle speed may be determined by the control device or information relating to such a determination may be received by the control device from another control system of the vehicle. The method may thus comprise a step of determining that an upcoming road section comprises an event that may be expected to require a reduction of vehicle speed compared to a current vehicle speed or a currently targeted vehicle speed. The term “targeted vehicle speed” shall in the present disclosure be interpreted broadly, and may for example be a set speed of a cruise control of the vehicle or a legally set speed limit, but is not limited thereto.

The maximum allowable vehicle speed profile mentioned above may be dependent of factors such as a maximum allowable lateral acceleration of the vehicle and/or maximum allowable wheel slippage. A maximum allowable lateral acceleration may for example be a maximum allowable lateral acceleration defined or otherwise selected by a control system of the vehicle, or a maximum allowable lateral acceleration set by a driver of the vehicle. Similarly, a maximum allowable wheel slippage may be defined or selected by a control system of the vehicle or set by a driver of the vehicle. The maximum allowable vehicle speed profile provides a maximum allowable vehicle speed at every distance point of the upcoming road section ensuring that the vehicle may be safely driven throughout the upcoming road section. Methods for determining a maximum allowable vehicle speed profile for an upcoming road section are as such previously known in the art and will therefore not be discussed further in the present disclosure.

The herein described method for controlling vehicle speed further comprises a step of, based on the determined maximum allowable vehicle speed profile, determining a desired vehicle speed profile. Said desired vehicle speed profile is designed to achieve at least one desired characteristic, such as comfort for a driver of the vehicle and/or to achieve a desired drivability of the vehicle. The drivability may for example be dependent of a driving mode (also known as performance mode) selected by e.g. a driver of the vehicle. Examples of such driving modes include an economy driving mode, a standard driving mode, and a power driving mode, but are not limited thereto. The desired vehicle speed profile is determined so as to reach a minimum point of the determined maximum allowable speed profile. This means that the desired vehicle speed profile is determined so that the vehicle, if following the desired vehicle speed profile, will reach a vehicle speed corresponding to the lowest maximum allowable speed, as defined by the determined maximum allowable speed profile, at a distance point which corresponds to the distance point at which this lowest maximum vehicle speed must be reached according to the determined maximum allowable vehicle speed profile, or suitably in front thereof by a preselected distance offset. The latter alternative thus results in the desired vehicle speed profile reaching the lowest maximum allowable speed at a distance point in front of the minimum point of the determined maximum allowable speed profile. It should here be noted that the above mentioned preselected distance offset may be dependent of the lowest maximum allowable vehicle speed defined by the determined maximum vehicle speed profile. For example, the preselected distance offset may be smaller in case of a lower lowest maximum allowable vehicle speed of e.g. 20 km/h compared to a higher lowest maximum allowable vehicle speed of e.g. 60 km/h. Furthermore, the desired vehicle speed profile is determined so as to avoid a vehicle speed, at any distance point of the upcoming road section, which is above the determined maximum allowable vehicle speed profile. In other words, the desired vehicle speed profile defines, for each distance point, a vehicle speed which is equal to or lower than the vehicle speed defined by the determined maximum allowable vehicle speed profile at said distance point. Furthermore, the desired vehicle speed profile should suitably be as close as possible to the determined maximum allowable speed profile while achieving the desired characteristic. The reason therefore is that if the desired vehicle speed profile would deviate too much from the determined maximum allowable speed profile, a following braking step (as will be described below) according to the present method would result in an unduly high reduction of average vehicle speed. This in turn leads to longer duration for the vehicle to travel the upcoming road section and may also cause irritation to a possible driver of the vehicle as well as to drivers of other vehicles travelling on the same road section.

The herein described method for controlling vehicle speed further comprises a step of simulating vehicle speed for at least an initial portion of the upcoming road section in case the vehicle would be braked according to a first brake mode, thereby obtaining a simulated vehicle speed profile for the first brake mode. An initial portion of the upcoming road section is here intended to mean the first part of the upcoming road section seen from a current position of the vehicle, i.e. a portion of the upcoming road section which is closest to the vehicle. Preferably, the vehicle speed is simulated at least to a distance point corresponding to the minimum point of the determined maximum allowable vehicle speed profile. In other words, said initial portion of the upcoming road section may constitute the distance between a current position of the vehicle (assuming that the above discussed upcoming road section is immediately in front of the vehicle) and the distance point corresponding to the minimum point of the determined maximum allowable vehicle speed profile. It is naturally possible to simulate vehicle speed for the whole upcoming road section, if desired, although this is not necessary for the purpose of the herein described method.

Simulation of a vehicle speed profile for an upcoming road section per se is nowadays well known to a person skilled in the art and will therefore not be described in detail here. Examples of factors that may typically be considered in such a simulation, in addition to geographical data (including topography) relating to the upcoming road section, include for example current vehicle speed, vehicle configuration, vehicle load etc. Advanced simulations of vehicle speed profiles may also take into consideration additional factors, such as weather conditions and/or traffic conditions.

The above described simulation of vehicle speed may suitably be performed under the condition of braking according to the brake mode being requested at a current point in time, or, in case the upcoming road section starts a distance in front of a current vehicle position, at a point in time at which the vehicle is estimated to reach the upcoming road section. A current point in time is here intended to mean a point in time at which the simulation of vehicle speed is performed and is therefore associated with a current position of the vehicle. It should here be noted that the actual activation of braking power by usage of a brake mode when a request therefore has been generated occurs with a certain delay depending for example on activation time of the means by which a braking force is applied (such as the activation time of one or more brake systems). Furthermore, the simulation as such may also cause a certain delay. However, such factors may easily be considered when performing the simulation. When discussed herein, the expression “if braking . . . would currently be requested” or similar expressions should therefore be interpreted as taking into account such delaying factors in the actual application of braking power/force according to a brake mode.

However, the present method does typically not comprise any prediction as to the point in time at which a brake mode should be activated. Instead, each simulation of a vehicle speed profile for any portion of the upcoming road section is suitably made under the condition of a request for reduction of vehicle speed by usage of a brake mode being generated at a point in time essentially corresponding to the point in time at which said simulation is made (suitably taking into account the delaying factors mentioned above). As an alternative to perform said simulation of vehicle speed under the condition of braking according to the brake mode being requested at a current point in time, the simulation of vehicle speed may be performed under the condition of braking according to the brake mode being requested after a preselected time (for example after 5 seconds, 8 seconds or 10 seconds) has passed from the point in time at which the simulation of vehicle speed is performed.

The herein described method for controlling vehicle speed further comprises a step of, when the obtained simulated vehicle speed profile for the first brake mode fulfils at least a first predefined criterion, said first predefined criterion being dependent of the determined desired vehicle speed profile, braking the vehicle in accordance with the first brake mode. In other words, when it is determined that the obtained simulated vehicle speed profile for the first brake mode fulfils at least said first predefined criterion, a request for braking of the vehicle according to the first brake mode is generated. In case the vehicle speed profile has been simulated for an upcoming road section starting from a current vehicle position, said braking is suitably initiated as soon as possible after it has been determined that the obtained simulated vehicle speed profile for the first brake mode fulfils at least said first predefined criterion. However, in case the vehicle speed profiled has been simulated for a road section starting a distance in front of the vehicle, said braking is suitably initiated when the vehicle reaches or is estimated to reach the starting point of said road section.

Various brake modes available for braking a specific vehicle may today typically be pre-ranked by e.g. the vehicle manufacturer based on various parameters, such as energy efficiency and/or wear of constituent components of the vehicle, in combination with the braking power available by the different brake modes. The driving mode (performance mode) may also be considered when pre-ranking the brake modes. Such a pre-ranking of the brake modes thus leads to one brake mode being prioritized over another brake mode. The first brake mode mentioned above may suitably be the brake mode having the highest ranking of the available brake modes for the vehicle, i.e. being the most preferred brake mode to meet the parameters used for the pre-ranking. Data relating to the pre-ranking may be stored in the control device described herein or retrieved by said control device from other sources, such as another control system onboard the vehicle or a remote control center. In other words, the control device described herein may be configured to determine said first brake mode based on stored data relating to a priority ranking of available brake modes by which the vehicle may be braked.

According to one exemplifying embodiment of the above mentioned pre-ranking of brake modes, freewheeling may be the brake mode having the highest priority, followed by coasting, and thereafter various brake modes using one or more auxiliary brake systems of the vehicle, optionally in combination with the service brakes.

The herein described method may further comprise a step of simulating vehicle speed for (at least) said initial portion of the upcoming road section in case the vehicle would be braked according to a second brake mode, thereby obtaining a simulated vehicle speed profile for the second brake mode. Said step may for example be performed essentially simultaneously with the simulation of the vehicle speed in case the vehicle would be braked according to the first brake mode. Alternatively, the step of simulating vehicle speed under the condition of the vehicle being braked according to the second brake mode may be performed only when the obtained simulated vehicle speed profiled for the first brake mode does not fulfil the first predefined criterion. It should here be noted that simulations of vehicle speed for one or more additional brake modes (i.e. brake modes other than the first and second brake modes) for the initial portion of the upcoming road section may naturally also be performed, if desired. The obtained simulated vehicle speed profile for the second brake mode may thereafter be compared with the desired vehicle speed profile for the purpose of determining if it fulfils the first predefined criterion. As previously mentioned, the first predefined criterion is dependent of the determined desired vehicle speed profile. The purpose of such a comparison is to determine if the second brake mode is an appropriate brake mode under the current conditions. The second brake mode may be a brake mode having a lower ranking than the first brake mode according to the above described pre-ranking of available brake modes of the vehicle.

In case the obtained simulated vehicle speed profile for the first brake mode does not fulfil the first predefined criterion, but the obtained simulated vehicle speed profile for the second brake mode fulfils said first predefined criterion, the method may comprise a step of braking the vehicle in accordance with the second brake mode.

In the event that both the simulated vehicle speed profile for the first brake mode and the simulated vehicle speed profile for the second brake mode would fulfill the first predefined criterion, the method may comprise evaluating which one of the first brake mode and the second mode constitutes the most appropriate brake mode. This may for example be made from a pre-ranking of the brake modes as discussed above, or on basis of evaluation of energy consumption of the vehicle or the like. Thereafter, the method comprises braking the vehicle in accordance with the brake mode found to constitute the most appropriate brake mode of the first and second brake modes.

In accordance with the herein described method, braking the vehicle in accordance with a brake mode (for example the first brake mode or the second brake mode) is performed when the obtained simulated vehicle speed profile fulfils at least a first predefined criterion. Suitably, said first predefined criterion may be that the difference between an integral of the desired vehicle speed profile (i.e. the area under the curve representing said profile in a plot showing vehicle speed vs. distance) and an integral of the simulated vehicle speed profile for a defined distance interval, is less than a predefined threshold value. Said distance interval is defined by a distance point corresponding to an initial vehicle position for which the simulated vehicle speed profile has been made (which may for example be a current vehicle position) and a distance point at which the simulated vehicle speed profile coincides with the desired vehicle speed profile. Alternatively, said first predefined criterion may be that the difference between the integral of the desired vehicle speed profile and the integral of the simulated vehicle speed profile for the defined distance interval is less than a predefined threshold value and equal to or above zero. It should here be noted that the above mentioned predefined threshold value may be dependent of one or more parameters related to vehicle speed, for example the difference in vehicle speed between a set speed of a cruise control (if applicable) and the vehicle speed of the minimum point of the determined maximum allowable vehicle speed profile. Both of the above exemplified alternatives of the first predefined criterion ensure that the vehicle will not experience a too high “distance loss” when traveling the upcoming road section as a result of a too high reduction of vehicle speed during braking. Such a “distance loss” may for example be experienced by a driver as an unexpected increase in the distance to another vehicle in front of the driver's vehicle. However, the latter alternative of the first predefined criterion also ensures that the actual vehicle speed when the vehicle is braked will not exceed the vehicle speed defined by the desired vehicle speed profile at any distance point.

According to another alternative, the first predefined criterion may be that the simulated vehicle speed profile should not deviate from the desired vehicle speed profile more than a predefined speed threshold value (i.e. a specific value, such as 5 km/h) at any distance point in prior to the distance point at which the simulated vehicle speed profile coincides with the desired vehicle speed profile. Although this alternative may lead to the vehicle having a vehicle speed close to the desired vehicle speed profile when braked, it will not have the same advantage as the alternatives considering the difference between the integrals of the desired vehicle speed profile and simulated vehicle speed profile and may therefore lead to the above described “loss of distance” as a result of the vehicle (when braked) likely obtaining a lower average speed seen over the distance.

The step of braking the vehicle in accordance with a brake mode (such as the first brake mode or the second brake mode) according to the herein described method may be performed when only a first predefined criterion, which is dependent of the determined desired vehicle speed profile, is fulfilled. Alternatively, the step of braking the vehicle in accordance with a brake mode according to the herein described method may be performed when both the first predefined criterion and a second predefined criterion (and optionally further predefined criteria, if desired) are fulfilled. In contrast to the first predefined criterion, the second predefined criterion need not necessarily be dependent of the determined desired vehicle speed profile although this is preferred.

One example of such a second predefined criterion may be that the possible duration of braking according to the relevant brake mode, before a change to another brake mode may be necessary, is equal to or above a predefined minimum acceptable duration for the relevant brake mode. The reason for such a second predefined criterion may for example be to avoid unsuitable temporary changes in the operation of the vehicle which may unduly increase wear of constituent components of the vehicle and/or which may cause disturbance (which for example may lead to reduced driver comfort). As an illustrative example, such a second predefined criterion relating to a possible duration of braking according to a brake mode may for example be used for the purpose of avoiding multiple gear changes in a too short period of time. In case the first predefined criterion is related to difference between the integrals of the desired vehicle speed profile and simulated vehicle speed profile as discussed above, the second predefined criterion may alternatively be that the simulated vehicle speed profile should not deviate from the desired vehicle speed profile more than a predefined speed threshold value (i.e. a specific value, such as 5 km/h), or should be within a speed range about the desired vehicle speed profile, such as ±10%), at any distance point.

The herein described method may comprise a step of, based on the obtained simulated vehicle speed profile for the first brake mode, determining a duration of braking until the simulated vehicle speed profile coincides with the desired vehicle speed profile. In such case, the step of braking the vehicle in accordance with the first brake mode may performed not only when it is determined that the first predefined criterion is fulfilled but also when the determined duration is equal to or above a predefined minimum acceptable duration for the first brake mode. This constitutes an example of the step of braking the vehicle in accordance with the first brake mode being performed with the obtained simulated vehicle speed profile for the first brake mode fulfils both the first predefined criterion and a second predefined criterion, the second predefined criterion here constituting that the duration of braking until the simulated vehicle speed profile of the first brake mode coinciding with the determined desired vehicle speed profile being equal to or above the predefined minimum acceptable duration for the first brake mode.

It may in many instances be necessary or at least appropriate to alter the brake mode by which the vehicle is braked before the vehicle actually reaches the minimum point of the determined maximum allowable. The herein described method may therefore further comprise a step of, while the vehicle is braked in accordance with the first brake mode or the second brake mode and before the vehicle reaches the minimum point of the determined maximum allowable speed profile, simulating vehicle speed for at least an adjacent portion of the upcoming road section in case the vehicle would be braked according to a third brake mode. Thereby, a simulated vehicle speed profile for the third brake mode is obtained. When the vehicle is braked in accordance with the first brake mode or the second brake mode, it has already started to travel the upcoming road section for which the maximum allowable speed profile has been determined. For said reason, the term “adjacent portion of the upcoming road section” is here used for describing a portion of the road section for which the maximum allowable speed profile has been determined and which is immediately in front of the vehicle at the point in time at which the above mentioned simulation under the condition of the vehicle being braked according to the third brake mode is performed. In essence, this corresponds to the step the simulation of vehicle speed for at least an initial portion of the upcoming road section in case the vehicle would be braked according to the first brake mode or the second brake mode, with the exception of the vehicle currently being present at a different distance point of the road section for which the maximum allowable speed profile has been determined and thus that said adjacent portion may be only partly overlapping with or be different from the initial portion of said road section.

The obtained simulated vehicle speed profile for the third brake mode may then be compared to the determined desired vehicle speed profile for the purpose of determining whether it fulfils the first predefined criterion (and optionally the second predefined criterion where applicable). The method may then further comprise, when the obtained simulated vehicle speed profile for the third brake mode fulfils at least the first predefined criterion, braking the vehicle in accordance with the third brake mode. In other words, this means that if it is found that the vehicle may be braked according to the third brake mode in view of the simulated vehicle speed profile for said brake mode fulfilling the first predefined criterion, the method may comprise altering the brake mode by which the vehicle is braked from the first or second brake mode to the third brake mode.

When the vehicle approaches a distance point and/or a vehicle speed within a predetermined acceptable range of the minimum point of the determined maximum allowable vehicle speed profile, or when it is estimated that the vehicle will reach the distance point corresponding to said minimum point within a predefined duration, it may sometimes be suitable to essentially disregard the determined desired vehicle speed profile. This may for example be the case when the vehicle may be braked in a more energy efficient way the final portion of the road section, for which the maximum vehicle speed profile has been determined compared to if it would be braked according to the brake mode for which a simulated vehicle speed profile fulfils the first predefined criterion. More specifically, it may for example be suitable to alter the brake mode to coasting, unless the vehicle is already braked through coasting, in case the vehicle may safely reach the minimum point of the determined maximum allowable vehicle speed profile (without the vehicle speed, at any distance point, exceeding the determined maximum allowable vehicle speed profile).

Therefore, the herein described method may, if desired, comprise a step of, when the vehicle (i) reaches a distance point which is equal to or less than a predetermined distance from the minimum point of the determined maximum allowable speed profile, (ii) is estimated to reach a distance point corresponding to the minimum point of the determined maximum allowable speed profile within a predefined duration and/or (iii) reaches a vehicle speed within a predetermined acceptable speed range of the minimum point of the determined maximum allowable speed profile, determining whether the vehicle may reach a vehicle speed equal to or lower than a vehicle speed of the minimum point of the determined maximum allowable speed profile at said minimum point of the determined maximum allowable speed through braking of the vehicle by coasting. This may be made independently of the determined desired vehicle speed profile. The method may then comprise a step of, when it is determined that the vehicle may reach a vehicle speed equal to or lower than the vehicle speed of the minimum point of the determined maximum allowable speed profile at the minimum point of the determined maximum allowable speed profile through braking the vehicle by coasting, initiating braking of the vehicle by coasting.

The herein described method for controlling vehicle speed may suitably be incorporated in a cruise control of a vehicle. Such a cruise control may suitably be a look-ahead cruise control, although outer cruise controls are also plausible. When the herein described method is incorporated in a cruise control, it may suitably be configured to temporarily override a control function configured to control vehicle speed in accordance with a current set speed (such set speed for example selected by a driver of the vehicle) of the cruise control in situations where is it determined that an upcoming road section comprises an event expected to require a reduction of vehicle speed compared to a predefined speed range of the set speed. Thereby, the cruise control may be used over a larger range of driving situations, such as also when driving on country roads comprising more events that may require alteration of vehicle speed compared to highway driving. The extended range of driving situations during which the cruise control may be used also inherently allows for an extended use of other energy conserving functions that may be incorporated in the cruise control. Furthermore, when a cruise control comprises the herein described method, the vehicle may be safely and efficiently operated without compromising driver comfort or behaving in a manner which is unexpected by e.g. a driver of the vehicle or surrounding traffic.

The performance of the herein described method for controlling vehicle speed of a vehicle may be governed by programmed instructions. These programmed instructions typically take the form of a computer program which, when executed in or by a control device, causes the control device to effect desired forms of control action. Such instructions may typically be stored on a computer-readable medium.

The present disclosure further relates to a control device configured to control vehicle speed of a vehicle in accordance with the method described above. The control device may be configured to perform any one of the steps of the method for controlling vehicle speed of a vehicle as described herein.

More specifically, the present disclosure provides a control device configured to control vehicle speed of a vehicle, wherein the control device is configured to determine a maximum allowable vehicle speed profile for an upcoming road section comprising an event expected to require a reduction of vehicle speed. The control device is further configured to, based on the determined maximum allowable vehicle speed profile, determine a desired vehicle speed profile to reach a minimum point of the determined maximum allowable speed profile while avoiding vehicle speeds above the maximum allowable vehicle speed profile, said desired vehicle speed profile being designed to achieve a desired characteristic. Moreover, the control device is configured to simulate vehicle speed for at least an initial portion of the upcoming road section in case the vehicle would be braked according to a first brake mode, thereby obtaining a simulated vehicle speed profile for the first brake mode. The control device is also configured to, when the obtained simulated vehicle speed profile for the first brake mode fulfils at least a first predefined criterion, which is dependent of the determined desired vehicle speed profile, brake the vehicle in accordance with the first brake mode.

The control device may comprise one or more control units. In case the control device comprises a plurality of control units, each control unit may be configured to control a certain function/action or a certain function/action may be divided between more than one control units. The control device may be a control device of the vehicle. Alternatively, one or more control units of the control device may be arranged remote from the vehicle, for example at a remote control center or the like.

The present disclosure also relates to a vehicle comprising the above-described control device. The vehicle may for example be a land-based heavy vehicle, such as a truck or a bus, but is not limited thereto. The vehicle may be configured to be operated by a driver (fully or partially) or be an autonomous vehicle. The vehicle may further comprise one or more brake systems configured to brake the vehicle, and which may be configured to be operated in accordance with different brake modes. The vehicle may be a vehicle driven by a combustion engine only. Alternatively, the vehicle may be a hybrid vehicle in which case the vehicle comprises an electrical machine in addition to a combustion engine. The vehicle may also be a fully electrical vehicle in which case it does not comprise a combustion engine, but comprises one or more electrical machines acting as propulsion unit(s).

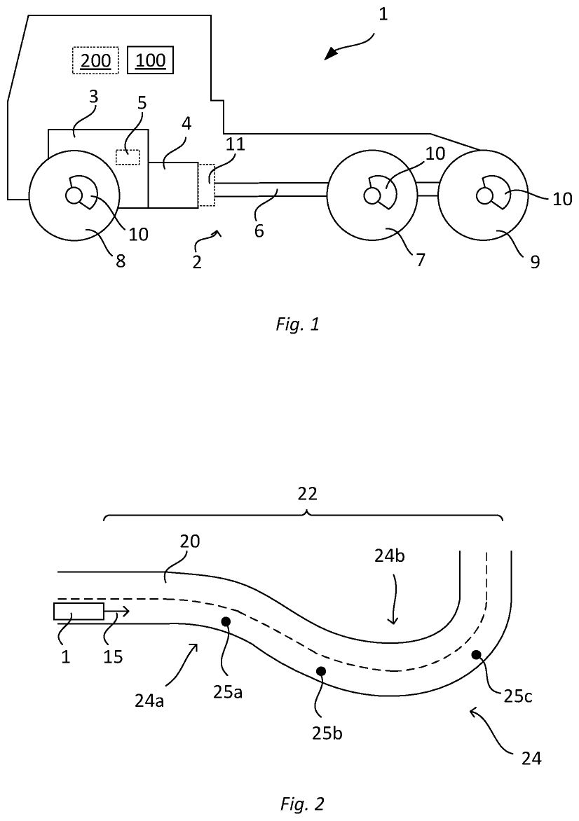

FIG. 1 schematically illustrates a side view of an example of a vehicle 1, here illustrated as a truck. The vehicle 1 comprises a powertrain 2 comprising a combustion engine 3 serving as a propulsion unit, and a gearbox 4. The combustion engine 3 may be connected to the gearbox via a clutch (not shown). The gearbox 4 may be connected to the driving wheels 7 of the vehicle 1 via an output shaft 6 of the gearbox 4. The vehicle further comprises front wheels 8 and optionally also tag axle wheels 9. It should be noted that although FIG. 1 illustrates a vehicle 1 comprising driving wheels 7 arranged in front of tag axle wheels 9, and thus a driven axle in front of the tag axle, a possible tag axle may alternatively or additionally be arranged in front of the drive axle in case the vehicle comprises such a tag axle. The vehicle 1 may alternatively, or additionally, comprise a plurality of driven axles with associated driving wheels 7.

The vehicle 1 may comprise service brakes 10 arranged at the respective driving wheels 7, and preferably also at any other wheel of the vehicle as shown in the figure. The vehicle 1 may further comprise at least one auxiliary brake system 5 whose deliverable braking power is dependent of the speed of the combustion engine 3; for example a compression release brake system, an exhaust brake system, or a variable vane brake system. The vehicle 1 may additionally or alternatively comprise an auxiliary brake system whose deliverable braking power is essentially independent of the speed of the combustion engine, such as a retarder 11. Such a retarder 11 may for example be connected to an output shaft of the gearbox 4 as illustrated in the figure. Alternatively, the retarder may be connected to a shaft of the combustion engine.

As previously mentioned, the present disclosure is not limited to a vehicle driven by a combustion engine. The vehicle 1 may additionally, or alternatively, comprise one or more electrical machines (not shown). In case the vehicle comprises at least one electrical machine, the vehicle may also comprise an auxiliary brake system in the form of a regenerative brake system (not shown). In a regenerative brake system, an electrical machine may be operated as generator for the purpose of converting kinetic energy of the vehicle to electrical energy which may be used to charge an energy storage device (not shown) of the vehicle. The energy stored in the energy storage device may thereafter be used for the purpose of driving the electrical machine when the electrical machine is operated as a propulsion unit of the vehicle.

The vehicle 1 may further comprise the control device 100 configured to control vehicle speed of the vehicle as described herein. Said control device 100 may for example be configured to control any one of the above mentioned brake systems of the vehicle 1 for the purpose of controlling the vehicle speed 1.

The vehicle 1 may further comprise a cruise control system 200. The control device 100 may be a part of the cruise control system 200, or be separate from the cruise control system 200 but configured to communicate therewith.

FIG. 2 schematically illustrates an exemplifying situation where a vehicle 1, such as the vehicle shown in FIG. 1, travels on a road 20 in a direction as illustrated by the arrow 15. An upcoming road section of the road 20,, illustrated by bracket 22 for ease of illustration, may comprise an event 24 that may require a reduction of the travelling speed of the vehicle 1 compared to a current vehicle speed in order for the vehicle to safely pass said event 24. The event 24 that may require a reduction of travelling speed of the vehicle 1 is in the figure illustrated as composed of a first slight curve 24a to the right as seen in the travelling direction of the vehicle, followed by a substantially U-shaped curve 24b. It should however be noted that the event 24 that may require a reduction of vehicle speed may be any type of event as described herein, and could thus alternatively be for example a speed sign or roundabout. The maximum allowable vehicle speed along the upcoming road section 22 to ensure that the vehicle 1 may safely pass the event 24 would typically vary between different distance points 25a, 25b, 25c of the upcoming road section 22. For the event 24 illustrated in the figure, the maximum allowable vehicle speed would typically be lower at distance point 25c compared to distance point 25a as a result of the curvature of the road 20. This means that, for the upcoming road section 22 comprising the event 24, a maximum allowable speed profile may need to be determined.

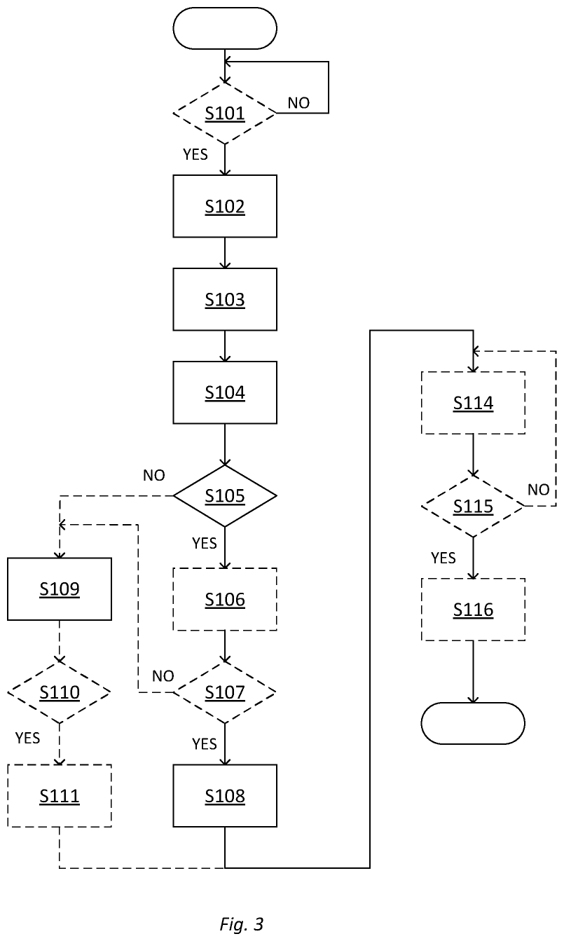

FIG. 3 represents a flowchart schematically illustrating one exemplifying embodiment of the herein described method for controlling vehicle speed of a vehicle. In the flowchart, optional steps are illustrated by dashed boxes/lines.

The method may comprise a step 101 of determining whether an upcoming road section comprises an event that may require a reduction of vehicle speed compared to a current vehicle speed or a currently targeted vehicle speed. A currently targeted vehicle speed may for example be a set speed of a cruise control, if present and activated. In case the upcoming road section does not comprise such an event, the method may be reverted to start. However, in case the upcoming road section comprises an event that may require a reduction of vehicle speed, the method proceeds to a subsequent step.

The method comprises a step S102 of determining a maximum allowable vehicle speed profile for an upcoming road section comprising an event expected to require a reduction of vehicle speed.

The method further comprises a step S103 of, based on the determined maximum allowable vehicle speed profile obtained in step S102, determining a desired vehicle speed profile to reach a minimum point of the determined maximum allowable speed profile while avoiding vehicle speeds above the determined maximum allowable vehicle speed profile. The desired vehicle speed profile is designed to achieve a desired characteristic, such as driver comfort and/or meeting conditions for a currently activated performance mode.

The method further comprises a step S104 of simulating vehicle speed for at least an initial portion of the upcoming road section in case the vehicle would be braked according to a first brake mode, thereby obtaining a simulated vehicle speed profile for the first brake mode. It should here be noted that although step S104 is illustrated to be performed after step S103, the steps S103 and S104 may be performed in any order, including simultaneously. Step S104 may also for example be performed simultaneously with step S102, if desired.

After steps S103 and S104, the method proceeds to a step S105 of determining whether the simulated vehicle speed profile for the first brake mode (obtained in step S104) fulfils a first predefined criterion, said first predefined criterion being dependent of the determined desired vehicle speed profile (obtained in step S103). The first predefined criterion may for example be that a difference between an integral of the desired vehicle speed profile and an integral of the simulated vehicle speed profile for a distance interval is less than a predefined threshold value, optionally in combination with said difference being equal to or above zero. Said distance interval is defined by the distance point corresponding to an initial vehicle position for which the simulated vehicle speed profile has been made, and a distance point at which the simulated vehicle speed profile coincides with the desired vehicle speed profile. Said initial vehicle position may for example correspond to a current vehicle position in case the upcoming road section for which the simulation of the vehicle speed profile is performed is immediately in front of the vehicle.

In case it is determined in step S105 that the first predefined criterion is fulfilled, the method may proceed to a step S106 or to a step S108 as will be described below. In case it is determined in step S105 that the first predefined criterion is not fulfilled, the method may instead proceed to a step S109 that will be described below.

The method may optionally comprise a step S106 of, based on the obtained simulated vehicle speed profile for the first brake mode, determining a duration of braking until the simulated vehicle speed profile coincides with the desired vehicle speed profile. Thereafter, the method may proceed to a step S107 of determining whether the simulated vehicle speed profile fulfils a second predefined criterion, said second predefined criterion being that the duration obtained in step S106 being equal to or longer a predefined minimum acceptable duration for the first brake mode. In case said second predefined criterion is fulfilled, the method proceeds to step S108. However, in case the second predefined criterion is not fulfilled, the method may proceed to step S109. It should be noted here that although steps S106 and S107 are shown to be performed when it is determined in step S105 that the first predefined criterion is fulfilled, the steps S106 and S107 may alternatively be integrated in step S105.

The method further comprises a step S108 of, when the obtained simulated vehicle speed profile for the first brake mode fulfils at least the first predefined criterion (determined in step S105), braking the vehicle in accordance with the first brake mode.

As mentioned above, in case it is determined in step S105 that the first predefined criterion is not fulfilled for the obtained vehicle speed profile for the first brake mode (or that the second predefined criterion is not fulfilled as determined in step S107), the method may proceed to an optional step S109. In the figure, step S109 is shown as performed after step S105. It should however be noted that step S109 may alternatively be made in parallel with step S104, if desired.

Optional step S109 comprises simulating vehicle speed for at least said initial portion of the upcoming road section in case the vehicle would be braked according to a second brake mode, thereby obtaining a simulated vehicle speed profile for the second brake mode. After step S109, the method may proceed to a step S110 of determining whether the simulated vehicle speed profile for the second brake mode (obtained in step S109) fulfils the first predefined criterion discussed above. If so, the method may proceed to a step S111 of braking the vehicle in accordance with the second brake mode. Although not illustrated in the figure, the method may further comprise a step, integrated in step S110 or performed after step S109 of determining whether the obtained simulated vehicle speed profile for the second brake mode fulfills the second predefined criterion. In such a case, step S111 is performed in response to a determination that both the first predefined criterion and the second predefined criterion are fulfilled.

In case it is determined in step S111 that the obtained simulated vehicle speed profile for the second brake mode does not fulfil the first predefined criterion, the method may be ended or alternatively proceed to a step of simulating vehicle speed profile for a further brake mode (other than the first and second brake modes). In the latter case, the obtained simulated vehicle speed profile of said further brake mode may be compared with the determined desired vehicle speed profile for the purpose of determining whether the first predefined criterion is fulfilled and, if so, a step of braking the vehicle in accordance with said further brake mode.

After step S108 (or S111, if present), the method may optionally comprise a step S114 of simulating vehicle speed for at least an adjacent portion of the upcoming road section in case the vehicle would be braked according to a third brake mode, thereby obtaining a simulated vehicle speed profile for the third brake mode. Step 114 is performed when braking of the vehicle in accordance with the first brake mode (or alternatively the second brake mode) has been initiated. This would typically also mean that the vehicle has commenced its travel along the initial upcoming road section, and has thus passed a distance point at which step S104 was performed.

The method may further comprise a step S115 of determining whether the simulated vehicle speed profile for the third brake mode obtained in step S114 fulfils the first predefined criterion. In case it is determined that the obtained simulated vehicle speed profile for the third brake mode fulfils the first predefined criterion, the method may proceed to a step S116 of braking the vehicle according to the third brake mode. In case it is determined that the obtained simulated vehicle speed profile for the third brake mode does not fulfil the predefined criterion, the method may for example be reverted to step S114. Alternatively, the method may be ended or proceed to a step of simulating vehicle speed profile for yet a further brake mode (other than the first and third brake mode, and in case of step S111 being performed, also other than the second brake mode).

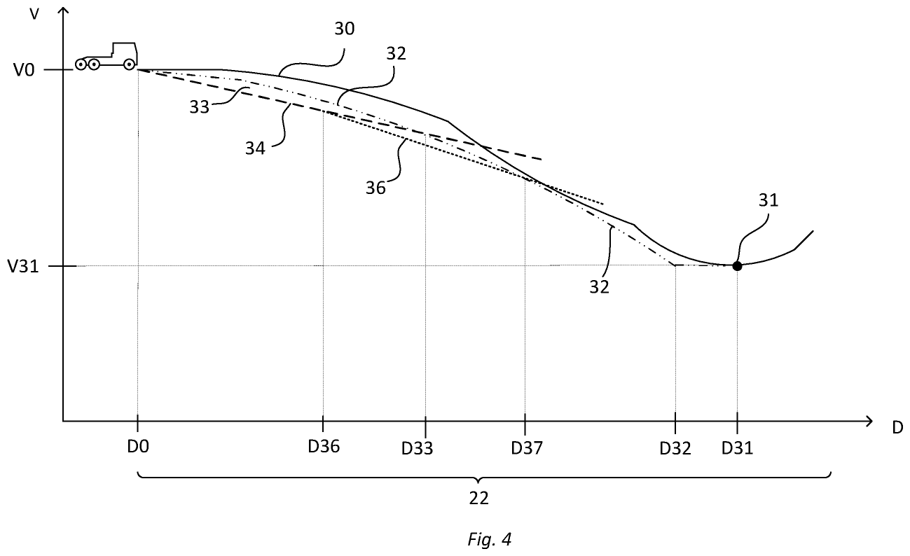

For the purpose of further illustrating the herein described method for controlling vehicle speed of a vehicle, FIG. 4 represents a graph of vehicle speed V versus distance D for an example of an upcoming road section 22 comprising an event requiring a reduction of vehicle speed. At the start of the herein described method, the vehicle 1 is present at a distance point D0 and has a vehicle speed V0. FIG. 4 further illustrates a determined maximum allowable vehicle speed profile 30. The determined maximum allowable speed profile 30 defines the highest possible speed of the vehicle 1 at any distance point along the upcoming road section 22 allowing the vehicle to safely travel along the upcoming road section 22, and comprises a minimum point 31. The minimum point 31 defines a lowest maximum allowable speed V31 of the vehicle together with the distance point D31 at which vehicle speed has to be reached.

It may typically not be appropriate, or even possible, to control the vehicle speed so as to exactly follow the determined maximum allowable speed profile 30. As previously mentioned, the herein described method comprises a step of determining a desired vehicle speed profile 32 designed to achieve a desired characteristic. The desired vehicle speed is determined so as to reach the minimum point 31 of the determined maximum allowable vehicle speed profile while also avoiding a vehicle speed, at any distance point, above the determined maximum allowable vehicle speed profile. The desired vehicle speed profile 32 may suitably be designed so as to ensure that the vehicle speed is reduced to the lowest maximum allowable speed V31 at an appropriate distance point D32 before the minimum point 31 of the determined maximum allowable speed profile. The distance between distance points D32 and D31 may be described as a preselected distance offset.

FIG. 4 further illustrates an obtained simulated vehicle speed profile 34 for a first brake mode of the vehicle. In accordance with the herein described method, the vehicle may be braked according to the first brake mode when it is determined that the simulated vehicle speed profile 34 for the first brake mode fulfils at least a first predefined criterion, wherein said first predefined criterion is dependent of the determined desired vehicle speed profile 32. As mentioned above, the first predefined criterion may be that a difference between an integral of the desired vehicle speed profile 32 and an integral of the simulated vehicle speed profile 34, for a defined distance interval, is less than a predefined threshold value, optionally in combination with said difference being equal to or above zero, wherein said distance interval is defined by a distance point corresponding to an initial vehicle position for which the simulated vehicle speed profile has been made and a distance point at which the simulated vehicle speed profile coincides with the desired vehicle speed profile 32. In the figure, said distance interval is defined by distance point D0, which corresponds to the distance point of the current vehicle position, and distance point D33. The above mentioned difference between the integral of the desired vehicle speed profile 32 and the integral of the simulated vehicle speed profile 34 represents the area 33 between the desired vehicle speed profile 32 and the obtained simulated vehicle speed profile 34 for the first brake mode. This area 33 represents a “distance loss” for the vehicle 1 when travelling along the road section 22 compared to if the desired vehicle speed profile 32 would be followed and should therefore preferably be small.

As the vehicle travels along the road section 22 while being braked according to for example the first brake mode, the present method may comprise simulating one or more further vehicle speed profiles for conditions where the vehicle would be braked according to other brake modes. The obtained simulated vehicle speed profiles therefrom may be compared to the desired vehicle speed profile for the purpose of determining if they fulfil the first predefined criterion. FIG. 4 illustrates an example of an obtained simulated vehicle speed profile 36 for a third brake mode (typically enabling a higher braking power than the first brake mode) obtained when the vehicle has reached the distance point D36. The distance point D36 here corresponds to an initial vehicle position for which the simulated vehicle speed profile 36 has been made. In case the obtained simulated vehicle speed profile 36 for the third brake mode fulfils the first predefined criterion, the herein described method may comprise altering the braking of the vehicle from the first brake mode to the third brake mode. In other words, in case the difference between an integral of the desired vehicle speed profile 32 and an integral of the simulated vehicle speed profile 36 for the distance interval defined by distance point D36 and a distance point D37, at which the simulated vehicle speed profile coincides with the desired vehicle speed profile, is less than a predefined threshold value, optionally in combination with said difference being equal to or above zero, the vehicle may according to the herein described method be braked according to the third brake mode.

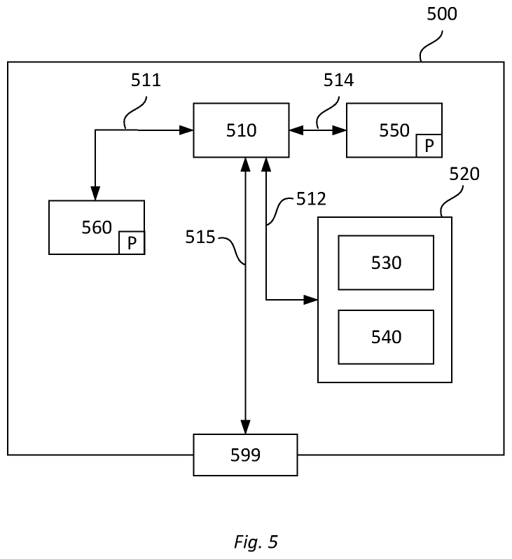

FIG. 5 schematically illustrates an exemplifying embodiment of a device 500. The control device 100 described above may for example comprise the device 500, consist of the device 500, or be comprised in the device 500.

The device 500 comprises a non-volatile memory 520, a data processing unit 510 and a read/write memory 550. The non-volatile memory 520 has a first memory element 530 in which a computer program, e.g. an operating system, is stored for controlling the function of the device 500. The device 500 further comprises a bus controller, a serial communication port, I/O means, an A/D converter, a time and date input and transfer unit, an event counter and an interruption controller (not depicted). The non-volatile memory 520 has also a second memory element 540.

There is provided a computer program P that comprises instructions for controlling vehicle speed of a vehicle. The computer program comprises instructions for determining a maximum allowable vehicle speed profile for an upcoming road section comprising an event expected to require a reduction of vehicle speed. The computer program further comprises instructions for, based on the determined maximum allowable vehicle speed profile, determining a desired vehicle speed profile to reach a minimum point of the determined maximum allowable speed profile while avoiding vehicle speeds above the determined maximum allowable vehicle speed profile, said desired vehicle speed profile being designed to achieve a desired characteristic. The computer program further comprises instructions for simulating vehicle speed for at least an initial portion of the upcoming road section in case the vehicle would be braked according to a first brake mode, thereby obtaining a simulated vehicle speed profile for the first brake mode. The computer program also comprises instructions for, when the obtained simulated vehicle speed profile for the first brake mode fulfils at least a first predefined criterion, which is dependent of the determined desired vehicle speed profile, braking the vehicle in accordance with the first brake mode.

The program P may be stored in an executable form or in a compressed form in a memory 560 and/or in a read/write memory 550.

The data processing unit 510 may perform one or more functions, i.e. the data processing unit 510 may effect a certain part of the program P stored in the memory 560 or a certain part of the program P stored in the read/write memory 550.

The data processing device 510 can communicate with a data port 599 via a data bus 515. The non-volatile memory 520 is intended for communication with the data processing unit 510 via a data bus 512. The separate memory 560 is intended to communicate with the data processing unit 510 via a data bus 511. The read/write memory 550 is adapted to communicate with the data processing unit 510 via a data bus 514. The communication between the constituent components may be implemented by a communication link. A communication link may be a physical connection such as an optoelectronic communication line, or a non-physical connection such as a wireless connection, e.g. a radio link or microwave link.

When data are received on the data port 599, they may be stored temporarily in the second memory element 540. When input data received have been temporarily stored, the data processing unit 510 is prepared to effect code execution as described above.

Parts of the methods herein described may be affected by the device 500 by means of the data processing unit 510 which runs the program stored in the memory 560 or the read/write memory 550. When the device 500 runs the program, methods herein described are executed.

1. A method, performed by a control device, for controlling vehicle speed of a vehicle, the method comprising the steps of:
determining a maximum allowable vehicle speed profile for an upcoming road section comprising an event expected to require a reduction of vehicle speed;
based on the determined maximum allowable vehicle speed profile, determining a desired vehicle speed profile to reach a minimum point of the determined maximum allowable speed profile while avoiding vehicle speeds above the determined maximum allowable vehicle speed profile said desired vehicle speed profile being designed to achieve a desired characteristic;
simulating vehicle speed for at least an initial portion of the upcoming road section in case the vehicle would be braked according to a first brake mode, thereby obtaining a simulated vehicle speed profile for the first brake mode; and
when the obtained simulated vehicle speed profile for the first brake mode fulfils at least a first predefined criterion, which is dependent of the determined desired vehicle speed profile braking the vehicle in accordance with the first brake mode.

2. The method according to claim 1, further comprising:
simulating vehicle speed for at least said initial portion of the upcoming road section in case the vehicle would be braked according to a second brake mode, thereby obtaining a simulated vehicle speed profile for the second brake mode; and
when the obtained simulated vehicle speed profile for the first brake mode does not fulfil said first predefined criterion and the obtained simulated vehicle speed profile for the second brake mode fulfils at least the first predefined criterion, braking the vehicle in accordance with the second brake mode.

3. The method according to claim 1, wherein the first predefined criterion is that of a difference between an integral of the desired vehicle speed profile and an integral of the simulated vehicle speed profile for a distance interval, defined by a distance point corresponding to an initial vehicle position for which the simulated vehicle speed profile has been made and a distance point at which the simulated vehicle speed profile coincides with the desired vehicle speed profile, is less than a predefined threshold value.

4. The method according to claim 1, further comprising:
based on the obtained simulated vehicle speed profile for the first brake mode, determining a duration of braking until the simulated vehicle speed profile coincides with the desired vehicle speed profile, and
wherein the step of braking the vehicle in accordance with the first brake mode is performed when the determined duration is equal to or above a predefined minimum acceptable duration for the first brake mode.

5. The method according to claim 1, further comprising:
while the vehicle is braked in accordance with the first brake mode and before the vehicle reaches the minimum point of the determined maximum allowable speed profile, simulating vehicle speed for at least an adjacent portion of the upcoming road section in case the vehicle would be braked according to a third brake mode, thereby obtaining a simulated vehicle speed profile for the third brake mode; and
when the obtained simulated vehicle speed profile for the third brake mode fulfils at least the first predefined criterion, braking the vehicle in accordance with the third brake mode.

6. The method according to claim 1, further comprising:
when the vehicle:
(i) reaches a distance point which is equal to or less than a predetermined distance from the minimum point of the determined maximum allowable speed profile,
(ii) is estimated to reach a distance point corresponding to the minimum point of the determined maximum allowable speed profile within a predefined duration, and/or
(iii) a vehicle speed within a predetermined acceptable speed range of the minimum point of the determined maximum allowable speed profile,
determining whether the vehicle may reach a vehicle speed equal to or lower than a vehicle speed of the minimum point of the determined maximum allowable speed profile at said minimum point of the determined maximum allowable speed profile through braking of the vehicle by coasting; and
when it is determined that the vehicle may reach a vehicle speed equal to or lower than the vehicle speed of the minimum point of the determined maximum allowable speed profile at the minimum point of the determined maximum allowable speed profile through braking the vehicle by coasting, initiating braking of the vehicle by coasting.

7. The method according to claim 1, wherein the method is incorporated in a cruise control of the vehicle.

8. The method according to claim 1, claims, wherein the event expected to require a reduction of vehicle speed comprises a curve of the road, a junction, a roundabout or a speed sign.

9. The method according to claim 1, further comprising a step of determining that an upcoming road section for the vehicle comprises an event expected to require a reduction of vehicle speed based on data selected from the group comprising data relating to the vehicle's geographical position in combination with map data or historical data, data obtained from another vehicle and/or from infrastructure, and/or data obtained from one or more sensors onboard the vehicle.

10. A computer program product stored on a non-transitory computer-readable medium, said computer program product for controlling vehicle speed of a vehicle, wherein said computer program product comprising computer instructions to cause one or more control devices to:
determine a maximum allowable vehicle speed profile for an upcoming road section comprising an event expected to require a reduction of vehicle speed;
based on the determined maximum allowable vehicle speed profile, determine a desired vehicle speed profile to reach a minimum point of the determined maximum allowable speed profile while avoiding vehicle speeds above the determined maximum allowable vehicle speed profile, said desired vehicle speed profile being designed to achieve a desired characteristic;
simulate vehicle speed for at least an initial portion of the upcoming road section in case the vehicle would be braked according to a first brake mode, thereby obtaining a simulated vehicle speed profile for the first brake mode; and
when the obtained simulated vehicle speed profile for the first brake mode fulfils at least a first predefined criterion, which is dependent of the determined desired vehicle speed profile, brake the vehicle in accordance with the first brake mode.

11. (canceled)

12. A control device configured to control vehicle speed of a vehicle, wherein the control device is configured to:
determine a maximum allowable vehicle speed profile for an upcoming road section comprising an event expected to require a reduction of vehicle speed;
based on the determined maximum allowable vehicle speed profile, determine a desired vehicle speed profile to reach a minimum point of the determined maximum allowable speed profile while avoiding vehicle speeds above the maximum allowable vehicle speed profile, said desired vehicle speed profile being designed to achieve a desired characteristic;
simulate vehicle speed for at least an initial portion of the upcoming road section in case the vehicle would be braked according to a first brake mode, thereby obtaining a simulated vehicle speed profile for the first brake mode; and
when the obtained simulated vehicle speed profile for the first brake mode fulfils at least a first predefined criterion, which is dependent of the determined desired vehicle speed profile, brake the vehicle in accordance with the first brake mode.

13. The control device according to claim 12, wherein the first predefined criterion is that of a difference between an integral of the desired vehicle speed profile and an integral of the simulated vehicle speed profile for a distance interval, defined by a distance point corresponding to an initial vehicle position for which the simulated vehicle speed profile has been made and a distance point at which the simulated vehicle speed profile coincides with the desired vehicle speed profile is less than a predefined threshold value.

14. A cruise control system configured to control vehicle speed of a vehicle the cruise control system comprising a control device configured to:
determine a maximum allowable vehicle speed profile for an upcoming road section comprising an event expected to require a reduction of vehicle speed;
based on the determined maximum allowable vehicle speed profile, determine a desired vehicle speed profile to reach a minimum point of the determined maximum allowable speed profile while avoiding vehicle speeds above the maximum allowable vehicle speed profile, said desired vehicle speed profile being designed to achieve a desired characteristic;
simulate vehicle speed for at least an initial portion of the upcoming road section in case the vehicle would be braked according to a first brake mode, thereby obtaining a simulated vehicle speed profile for the first brake mode; and
when the obtained simulated vehicle speed profile for the first brake mode fulfils at least a first predefined criterion, which is dependent of the determined desired vehicle speed profile, brake the vehicle in accordance with the first brake mode.

15. A vehicle comprising a control device configured to:
determine a maximum allowable vehicle speed profile for an upcoming road section comprising an event expected to require a reduction of vehicle speed;
based on the determined maximum allowable vehicle speed profile, determine a desired vehicle speed profile to reach a minimum point of the determined maximum allowable speed profile while avoiding vehicle speeds above the maximum allowable vehicle speed profile, said desired vehicle speed profile being designed to achieve a desired characteristic;
simulate vehicle speed for at least an initial portion of the upcoming road section in case the vehicle would be braked according to a first brake mode, thereby obtaining a simulated vehicle speed profile for the first brake mode; and
when the obtained simulated vehicle speed profile for the first brake mode fulfils at least a first predefined criterion, which is dependent of the determined desired vehicle speed profile, brake the vehicle in accordance with the first brake mode.

16. The method according to claim 1, wherein the first predefined criterion is that of a difference between an integral of the desired vehicle speed profile and an integral of the simulated vehicle speed profile for a distance interval, defined by a distance point corresponding to an initial vehicle position for which the simulated vehicle speed profile has been made and a distance point at which the simulated vehicle speed profile coincides with the desired vehicle speed profile, is: (i) less than a predefined threshold value, and (ii) equal to or above zero.

17. The control device according to claim 12, wherein the first predefined criterion is that of a difference between an integral of the desired vehicle speed profile and an integral of the simulated vehicle speed profile for a distance interval, defined by a distance point corresponding to an initial vehicle position for which the simulated vehicle speed profile has been made and a distance point at which the simulated vehicle speed profile coincides with the desired vehicle speed profile, is: (i) less than a predefined threshold value, and (ii) equal to or above zero.

18. The control device according to claim 12 further configured to:
simulate vehicle speed for at least said initial portion of the upcoming road section in case the vehicle would be braked according to a second brake mode, thereby obtaining a simulated vehicle speed profile for the second brake mode; and
when the obtained simulated vehicle speed profile for the first brake mode does not fulfil said first predefined criterion and the obtained simulated vehicle speed profile for the second brake mode fulfils at least the first predefined criterion, brake the vehicle in accordance with the second brake mode.

19. The control device according to claim 12 further configured to:
based on the obtained simulated vehicle speed profile for the first brake mode, determine a duration of braking until the simulated vehicle speed profile coincides with the desired vehicle speed profile, and
wherein the step of brake the vehicle in accordance with the first brake mode is performed when the determined duration is equal to or above a predefined minimum acceptable duration for the first brake mode.

20. The control device according to claim 12 further configured to:
when the vehicle:
(i) reaches a distance point which is equal to or less than a predetermined distance from the minimum point of the determined maximum allowable speed profile,
(ii) is estimated to reach a distance point corresponding to the minimum point of the determined maximum allowable speed profile within a predefined duration, and/or
(iii) a vehicle speed within a predetermined acceptable speed range of the minimum point of the determined maximum allowable speed profile,
determine whether the vehicle may reach a vehicle speed equal to or lower than a vehicle speed of the minimum point of the determined maximum allowable speed profile at said minimum point of the determined maximum allowable speed profile through braking of the vehicle by coasting; and
when it is determined that the vehicle may reach a vehicle speed equal to or lower than the vehicle speed of the minimum point of the determined maximum allowable speed profile at the minimum point of the determined maximum allowable speed profile through brake the vehicle by coasting, initiate braking of the vehicle by coasting.

21. The control device according to claim 12 further configured to: determine that an upcoming road section for the vehicle comprises an event expected to require a reduction of vehicle speed based on data selected from the group comprising data relating to the vehicle's geographical position in combination with map data or historical data, data obtained from another vehicle and/or from infrastructure, and/or data obtained from one or more sensors onboard the vehicle.
